(19) United States
(12) Patent Application Publication
(10) Pub. No.: US 2022/0200351 A1
(43) Pub. Date: Jun. 23, 2022

(54) CONTACTLESS CHARGING DRAWER FOR SMART GARMENTS

(71) Applicants: Analog Devices, Inc., Wilmington, MA (US); UNIVERSITY OF FLORIDA RESEARCH FOUNDATION, INC., Gainesville, FL (US)

(72) Inventors: Patrick RIEHL, Lynnfield, MA (US); Chin-Wei CHANG, Gainesville, FL (US)

(73) Assignees: Analog Devices, Inc., Wilmington, MA (US); UNIVERSITY OF FLORIDA RESEARCH FOUNDATION, INC., Gainesville, FL (US)

(21) Appl. No.: 17/556,352

(22) Filed: Dec. 20, 2021

Related U.S. Application Data
(60) Provisional application No. 63/128,474, filed on Dec. 21, 2020.

(51) Int. Cl. H02J 50/12; H02J 50/40; H02J 50/00

(52) U.S. Cl. CPC H02J 50/12; H02J 50/80; H02J 50/005; H02J 50/402

(57) ABSTRACT

A contactless charging drawer for smart garments using magnetic coupling links. A frame with a primary coil creates a magnetic field which couples with a secondary coil disposed a drawer. Smart garments, or any device, can then be safely charged in the drawer. The combination provides for a wireless power charging environment while adding an extra degree of freedom in impedance transformation without the need for electrical contacts to the drawer.

### CROSS-REFERENCE TO RELATED APPLICATIONS

This application is related to and claims the benefit of priority under 35 U.S.C. § 119(e) to U.S. Provisional Patent Application No. 63/128,474 entitled, “CONTACTLESS CHARGING DRAWER FOR SMART GARMENTS” filed on Dec. 21, 2020 is related to U.S. Provisional Patent Application No. 62/519,099 entitled, “SYSTEM AND METHOD FOR WIRELESS CHARGING OF SMART GARMENTS” filed on Jun. 13, 2017 and related to U.S. patent application Ser. No. 16/005,579 entitled, “SYSTEM AND METHOD FOR WIRELESS CHARGING OF SMART GARMENTS” filed on Jun. 11, 2018, all of which are hereby incorporated by reference in their entirety.

### FIELD OF THE DISCLOSURE

The present disclosure relates to techniques for wireless charging of smart textiles, such as smart garments. More specifically, this disclosure describes apparatuses and systems for contactless charging of smart garments in a safe environment.

### BACKGROUND

Smart clothing is an emerging market with tremendous growth potential. Among the proposed functions that could be integrated into clothing are vital sign monitoring, user interfaces, active heating and cooling, active comfort control, active displays, gesture recognition, posture monitoring and/or hazardous condition monitoring. Such functions generally require a power source, however.

Often, these devices include battery packs that last typically from a few hours to a couple of days. The constant use of these devices may require periodical charging. In some cases, such an activity may be tedious and may represent a burden to users. For example, a user may be required to carry chargers or additional batteries and may have to remember to plug in the device or the batteries for a suitable amount of time. In addition, users have to find available power sources to connect to. In many occasions, such an activity may render the clothing inoperable during charging. Wearable devices are designed, fabricated, and assembled with disparate shapes, sizes, and structures by a variety of suppliers. They are often operated with DC power from a battery. However, the battery is often small, compact, and light in weight so as to accommodate constraints of the wearable devices. Thus, the battery needs to be recharged after a period of use.

The recharger for the battery is usually customized for the particular wearable device. As a result, a user has to purchase multiple rechargers. In one instance, the user must carry around the appropriate recharger for use as needed with each wearable device as the battery becomes completely depleted.

Items of clothing are increasingly being provided with sensors, particularly in the area of sports, but also in the stationary or ambulatory monitoring of patients and workers. These sensors can measure physiological data of a wearer of such an item of clothing. For example, physiological data may include heart rate, electrocardiogram (ECG) signals, respiratory signals, current state of motion, body temperature, and many other types of data.

For example, heart rate can be measured through two electrodes that make contact with the skin of a human. The human heartbeat, in particular its so-called RR-Interval, brings about voltage changes on the skin, which can be measured by the two electrodes.

The measurement of respiration may take place through meander-shaped electrical conductors, which can be arranged in the chest and/or abdomen region and respectively represent an electrical coil and are connected to an electrical oscillator. Due to respiratory motion, the circumference of the chest and abdomen change, along the length of the conductors, the inductance of the coils, and finally the oscillation frequency. The alteration of the oscillation frequency can be evaluated and permits conclusions to be made with regard to the respiratory motion.

The state of motion of a human can be detected by way of position sensors or acceleration sensors. Position sensors are able to provide data with respect to their position in space, while acceleration sensors measure acceleration acting upon them. The sensors can be arranged at individual body parts such as the limbs for instance, in order to measure the motion and/or position of the body parts. Distance sensors can be used in order to measure the distance between individual body parts in relation to one another.

In addition to the advent of smart garments, the proliferation of handheld devices, mobile telephones, smart phones, electronic notepads, tablets, netbooks, e-readers, electronic personal music players and the like, the organization and charging of these devices have become an important concern for many consumers. Many Americans have multiple devices that need to be charged, re-charged, or synchronized at various periods of time or intermittently. These devices take up valuable space in an ever-shrinking home or workspace.

Smart garments can provide much better monitoring than smart watches due to its larger cover area. By distributing sensors all over the body, significant information can be acquired for healthcare or work safety purposes. In order for smart garments to be used daily, the garments must be comfortable, washable, and able to be charged in bulk. Wireless power transfer (WPT) with textile receiver (RX) coils is a great solution for all the objectives listed above. Since no connector is needed, the system can be fully-sealed to reach washability.

Multi-RXs wireless charging systems can be designed to charge multiple garments at the same time. One important feature of such system is the textile RX coil, as it affects the comfortability of garment as well as the charging efficiency.

Drawers and shelves can store, organize, secure and keep safe such devices. However, such devices often need to be charged so as to replenish drained internal or external batteries. Heretofore, the art has attempted to provide charging drawers with mechanical plug in devices. Thus, an object underlying embodiments of the present invention is to provide a safe, convenient charging environment.

There is a demonstrated need in the art for a wireless charging platform which avails itself to coupled inductive charging. The inventors of the present disclosure have recognized a need for contactless charging drawer.

For the foregoing reasons, there is a need for wireless power transmission systems capable of powering smart clothing, without requiring extra chargers or plugs and without compromising the safety and convenience of the devices. Furthermore, charging ports can act as entry points for moisture and dust, compromising the reliability of garments.

This overview is intended to provide an overview of subject matter of the present patent application. It is not intended to provide an exclusive or exhaustive explanation of the disclosure. Further limitations and disadvantages of conventional and traditional approaches will become apparent to one of skill in the art, through comparison of such systems with some aspects of the present disclosure as set forth in the remainder of the present application with reference to the drawings.

### SUMMARY OF THE DISCLOSURE

A contactless charging drawer for smart garments using magnetic coupling links. A frame with a primary coil creates a magnetic field which couples with a secondary coil disposed a drawer. Smart garments, or any device, can then be safely charged in the drawer. The combination provides for a wireless power charging environment while adding an extra degree of freedom in impedance transformation without the need for electrical contacts to the drawer.

According to one aspect, the present disclosure is a charging drawer system for smart garments comprising a frame and drawer.

According to another aspect of the present disclosure, the charging drawer is contactless.

According to another aspect of the present disclosure, the charging drawer provides for wireless power to devices.

According to another aspect of the present disclosure, the charging drawer has a frame.

According to another aspect of the present disclosure, the frame has a ferrous surrounding.

According to another aspect of the present disclosure, the frame has a first charging coil.

According to another aspect of the present disclosure, the drawer has a second charging coil.

According to another aspect of the present disclosure, the first and second charging coils are magnetically coupled.

According to another aspect of the present disclosure, the frame comprising an amplifier which is in electrical communication with the first coil.

According to another aspect of the present disclosure, the second coil is configured to be an impedance transformation from the first coil.

According to another aspect of the present disclosure, the second coil is configured to provide wireless energy to smart garments disposed in the drawer.

According to another aspect of the present disclosure, the charging drawer system comprises a second drawer.

According to another aspect of the present disclosure, the frame has a third charging coil configured to provide charging to a fourth charging coil disposed on the second drawer.

According to another aspect of the present disclosure, the system of primary charging coils disposed the frame to be driven is phase.

The drawings show exemplary contactless charging drawer circuits and configurations. Variations of these circuits, for example, changing the positions of, adding, or removing certain elements from the circuits are not beyond the scope of the present disclosure. The illustrate configurations, and complementary devices are intended to be complementary to the support found in the detailed description.

### BRIEF DESCRIPTION OF THE DRAWINGS

The present disclosure is best understood from the following detailed description when read with the accompanying figures. It is emphasized that, in accordance with the standard practice in the industry, various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

For a fuller understanding of the nature and advantages of the present invention, reference is made to the following detailed description of preferred embodiments and in connection with the accompanying drawings, in which:

FIG. 1A is an exemplary top-down view of a contactless charging drawer, in accordance with some embodiments of the disclosure provided herein;

FIG. 1B is an exemplary side view of a contactless charging drawer showing the field paths, in accordance with some embodiments of the disclosure provided herein;

FIG. 2 depicts an exemplary functional schematic of a contactless charging drawer, in accordance with some embodiments of the disclosure provided herein;

FIG. 3 is an exemplary side view of a contactless charging drawer, in accordance with some embodiments of the disclosure provided herein;

FIG. 4 illustrates a heuristic 3-coil model found in a contactless charging drawer, in accordance with some embodiments of the disclosure provided herein;

FIG. 5 is an exemplary side view of a contactless charging chest of drawers, in accordance with some embodiments of the disclosure provided herein;

FIGS. 6A-C is an exemplary side view of a contactless charging chest of drawers, in accordance with some embodiments of the disclosure provided herein; and

FIG. 7 depicts an exemplary functional schematic of a contactless charging system, in accordance with some embodiments of the disclosure provided herein.

### DETAILED DESCRIPTION

The present disclosure relates to techniques for wireless charging of smart textiles, such as smart garments. More specifically, this disclosure describes apparatuses and systems for contactless charging of smart garments in a safe environment. The inventors of the present disclosure contemplate the use a 3-coil (or any plurality) system for charging in a drawer. The magnetic coupling removes the need for electrical contacts, in addition to adding other beneficial feature which will be discussed in greater detail later in the disclosure.

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure are set forth in the proceeding in view of the drawings where applicable.

Wearable technology is everywhere in modern life in the form of discrete devices such as smart watches, fitness bands and earbuds. Wearables monitor heart rate, blood oxygen level and movements, and serve as a user interface to cloud services through mobile phones. These functions are typically realized with standalone gadgets that must be charged separately on their own docking stations. Furthermore, data collection is limited to those areas on the body where it is convenient to attach a gadget—typically the wrist or the ear.

The integration of sensing devices into clothing promises better access to sensing at distributed locations around the body—for example, ECG and respiration could be measured on the chest while pulse rate is measured at the wrist. Some consumer products integrating electronics into clothing have been released. For example, Levi's and Google have released a smart jacket with which you can control your mobile phone while keeping your phone in the pocket.

Typically, in such products, the electronic components are encased in a plastic housing that is attached to the garment for use and detached for charging or when the garment is washed. Thus, additional user intervention is required to maintain the garment. To offer a more user-friendly smart garment, we need to seal the electronic device completely so that it can survive machine washing. This implies that a charging port is not allowed—there is a need in the art to charge wirelessly.

The present disclosure begins with a basic WPT system and the implementation of WPT systems to hanger and drawer, both of which are commonly used for organizing clothes. The material and fabrication methods of textile RX coils are then discussed. The hanger system is optimized to achieve alignment-free feature. The inventors of the present disclosure have demonstrated that charging current varies by only 21% in an area where the coupling factor varies from 22.3% to 37.4%.

The drawer system is optimized to have constant charging ability regardless of the number of garments inside. The inventors have also demonstrated that the charging current stays stable when two additional shirts are added. A multi-drawer chest system is disclosed that can be designed to provide stable charging current everywhere inside the chest.

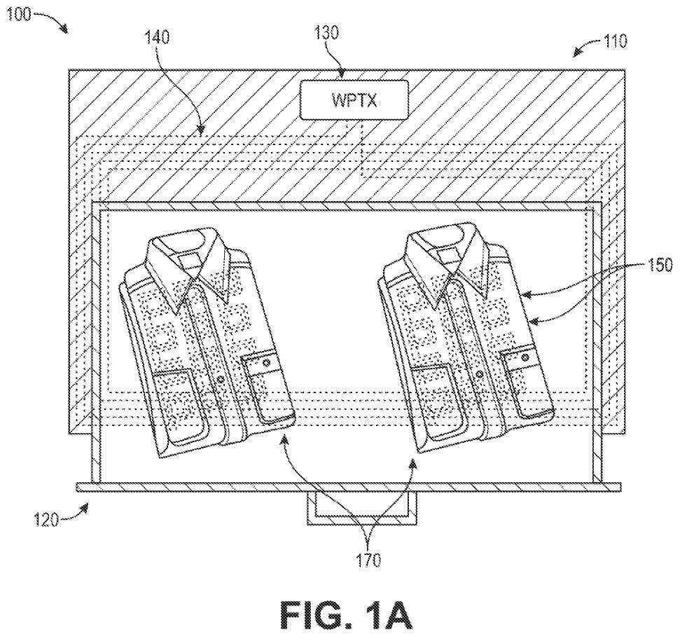

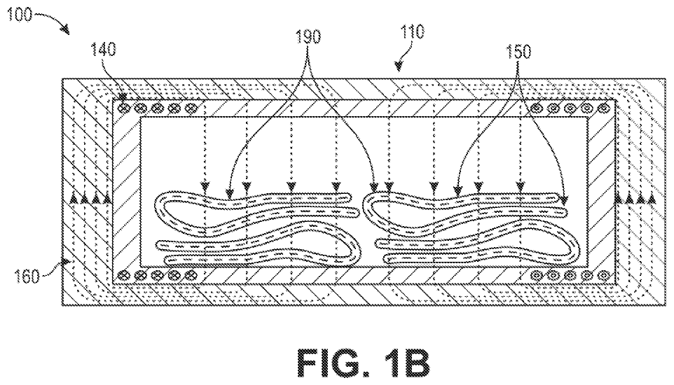

FIG. 1A is an exemplary top-down view of a contactless charging system 100, in accordance with some embodiments of the disclosure provided herein. Contactless charging system 100 comprises a wireless power transmitter (WPTX) 130, frame 110, drawer 120, transmitter coil (Tx) 140 and receiver coils (Rx) 190.

An object of the present disclosure is to provide an effortless user experience for recharging smart garments. State of the art smart garments are powered from disposable batteries or use detachable electronics that must be recharged on a dedicated, usually wired, charger. These approaches require the user to spend time and mental effort on recharging their clothes.

In the above identified applications incorporated by reference, an approach for effortless wireless charging of multiple garments of different shapes and sizes was outlined. This disclosure extends this concept.

In practice, WPTX 130 powers one or more transmitter coils thereby creating a B-field which is oriented orthogonally to the plane of the Tx coil 140 (i.e., out of the page of the drawing). The B-field gets magnetically coupled to the Rx coil 150 through induction. Electromagnetic or magnetic induction is the production of an electromotive force across an electrical conductor in a changing magnetic field. The induced current/EMF can be used to charge power storage devices, such as, batteries, capacitors, etc. In the present embodiment, the Rx coil array 150 is depicted in the smart garments. However, any device suitable for wireless charging is not beyond the scope of the present disclosure.

In one or more embodiments, the frame 110 and drawer 120 are, or a part of, a bureau or chest of drawer. However, any suitable device or furniture is not beyond the scope of the present invention.

FIG. 1B is an exemplary cross-sectional side view of a charging system 100 showing the induced magnetic field paths 160, in accordance with some embodiments of the disclosure provided herein. One of ordinary skill in the art can appreciate the current direction in (left side) and out (right side) of the page throughout the Tx coil(s) 140. As in a solenoid, this produces a magnetic field with a downward orientation within the drawer and upward outside thereof in order to complete the B-field pathways 160.

In practice, the current direction is alternated (e.g., AC) in order to produce a continually changing magnetic field. In one or more embodiments, this a simple sine wave, but any suitable waveform is not beyond the scope of the invention, such as, square-wave, saw tooth, ramp, pulse train, triangle, etc. As can be appreciated, the coupled magnetic field to the Rx coils 150 produce a voltage potential which can be used to power the device and/or charge the battery(ies).

In a charging drawer 120 design, the placement of the Tx coil 140 and amplifier have some conflicting requirements. The Tx coil 140 should be on the drawer (movable part) so that it can fully enclose the space within the drawer. It would be better for the amplifier to be on the frame (fixed part) since it will have a wired connection to line power. Also, it is desirable to detect that the drawer is open to stop transmitting power and prevent human exposure. The following embodiment which achieves these objectives will now be described in detail.

In practice, Tx coil 140 is energized with alternating current. This produces a magnetic field which energizes relay coil through magnetic coupling. This in turn can be used to energize the Rx coil 150 disposed in the garments 190. The electromechanics will now be discussed in more analytical detail.

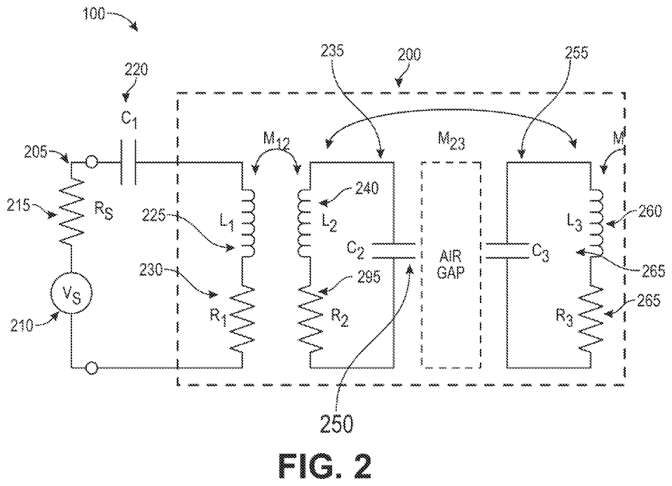

FIG. 2 depicts an exemplary functional schematic of a contactless charging system 200, in accordance with some embodiments of the disclosure provided herein. Tx RLC circuit 205 comprises a voltage source Vₛ 210, capacitor C₁ 220, inductor L₁ 225, resistor R₁ 230, and source resistor Rₛ 215. Tx RLC 205 comprises an RLC circuit (also known as a resonant circuit, tuned circuit, or LCR circuit) which is an electrical circuit consisting of a resistor (R), an inductor (L), and a capacitor (C), connected in series or in parallel. The present embodiment is a depicted in series but parallel is not beyond the scope of the present invention.

The circuit forms a harmonic oscillator for current, and resonates in a similar way as an LC circuit. Introducing the resistor increases the decay of these oscillations, which is also known as damping. The resistor also reduces the peak resonant frequency. In ordinary conditions, some resistance is unavoidable even if a resistor is not specifically included as a component; an ideal, pure LC circuit exists only in the domain of superconductivity, a physical effect demonstrated to this point only at temperatures far below ambient temperatures found anywhere on the Earth's surface.

Relay RLC circuit 235 comprises capacitor C₂ 250, inductor L₂ 240, and resistor R₂ 295. Rx RLC circuit 255 comprises capacitor C₃ 265, inductor L₃ 260, and resistor R₃ 265. The three RLC are coupled through mutual inductance. Mutual Inductance is the interaction of one coil magnetic field on another coil as it induces a voltage in the adjacent coil.

When an electromotive force (EMF) is induced into an adjacent coil situated within the same magnetic field, the EMF is said to be induced magnetically, inductively or by Mutual induction, symbol (M). Then when two or more coils are magnetically linked together by a common magnetic flux, they are said to have the property of Mutual Inductance. Mutual Inductance is the basic operating principle of the transformer, motors, generators and any other electrical component that interacts with another magnetic field. Then we can define mutual induction as the current flowing in one coil that induces a voltage in an adjacent coil.

As is known in the art, M₁₂ is the analytical notation characterizing the coupling of Tx coil 225 with relay coil 240. Similarly, M₂₃ is the analytical notation characterizing the coupling of relay coil 240 with Rx coil 260. As can be appreciate by one skilled in the art Tx RLC circuit 205 is stimulated by voltage source V, 210. This resonance produces a B-field in and around inductor L₁ 225 which is captured in part inductor L₂ 240. In turn, this field reception harmonically stimulates an oscillation in relay RLC circuit 235. Carrying this a step further Rx RLC circuit 255 is primarily powered through its mutual inductance M₂₃ of relay coil which is how batteries can be charged in the garments.

Although it would be possible to have the AC voltage source Vₛ 210 directly drive the resonator formed by C₂ 250 and L₂ 240, the transformer M12 provides several advantages. First, it allows for a voltage transformation to either multiply up or divide down the voltage applied to the resonator. This gives a way to adjust the design to accommodate a convenient voltage at Vₛ 210 while further accommodating the desired magnetic field within L₂ 240. Secondly, according to a well-known property of transformers, an impedance inversion occurs across the transformer M12. For example, if L₁ 225 is driven by a constant AC current, L₂ 240 will have a constant induced voltage. It is desirable to have a constant current in L₂ 240 such that the presence of one receiver in the field does not affect the magnetic field applied to another receiver. It is also desirable that the driver represented by Vs 210 be a constant ac voltage, as this is a much more common amplifier type to realize. The transformer M12 allows for a roughly constant current to be applied to the relay coil using a voltage amplifier.

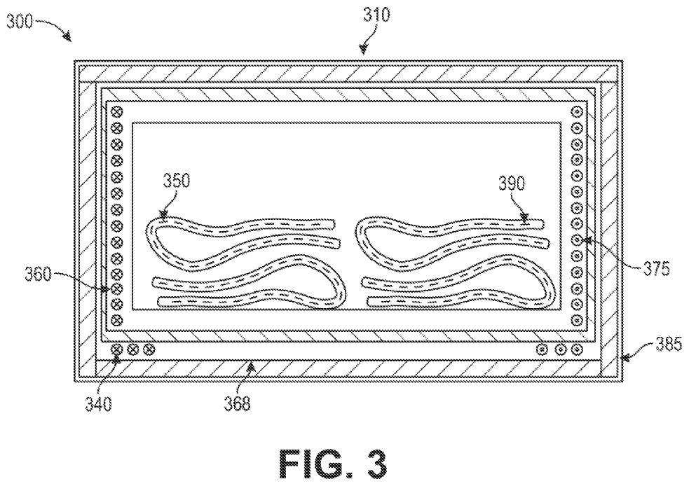

FIG. 3 is an exemplary side view of a contactless charging system 300, in accordance with some embodiments of the disclosure provided herein. In one or more embodiments, contactless charging system 300 comprises drawer 375, frame 385 and back iron 368. The frame 385 comprises one or more Tx coils 340 and other standard accoutrements which are standard in the art for providing and receiving drawers, such as, slides, glides, rails, runners, and tracks, etc.

FIG. 3 illustrates a further advantage of the 3-coil design. Note that the Tx coil 340 is fixed to the frame of the drawer assembly while the relay coil 360 is fixed to the drawer 373. A resonant capacitor C2 would also be fixed to the drawer 373. The drawer 375 therefore requires no wiring to a power source. This makes the construction of the drawer assembly easier, since there is typically no mechanical linkage between a drawer 373 and a drawer frame 385. If a 2-coil design were used, the drawer would have to be wired to a power source. This wire could become a failure point as the user could pull the drawer out too far and disconnect the wire. Not having a wired connection to the drawer also improves the safety of the design since a short-circuit to the power source cannot be formed.

In addition to similar coupling/mating items, drawer comprises on or more relay coils 360. In practice the relay coils 360 couple with the Rx coils 350, 390. In the present embodiment, back iron 368 comprises a ferrite material which surrounds the drawer and acts like a Faraday cage to prevent undesirable field leakage outside the contactless charging drawer. However, any highly conductive and/or lossy material having a penetration depth of greater than a few wavelengths is not beyond the scope of the present invention.

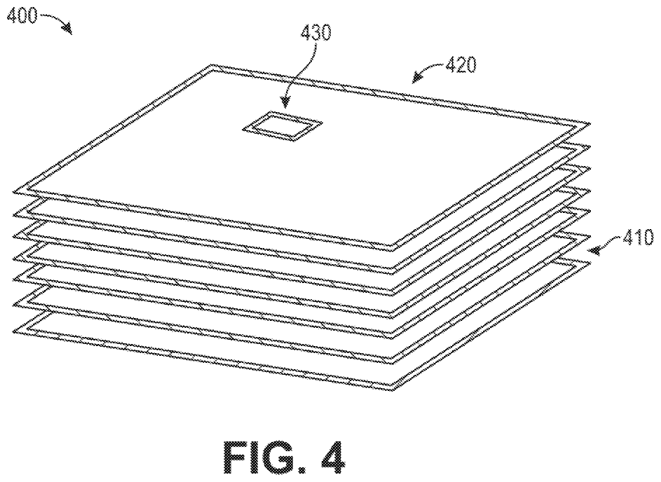

FIG. 4 illustrates a heuristic 3-coil model found in a contactless charging drawer 400, in accordance with some embodiments of the disclosure provided herein. In one or more embodiments, Tx coil 410 has a single turn and relay coil 420 has 7 turns, with Rx coil 430 having turn somewhere in between depending on end-user product. However, any ratio and/or number of turns are not beyond the scope of the present disclosure. Similarly, any plurality of additional magnetic coupling links remains within the scope of the invention.

Continuing with the comparison to a 2-coil system, when the drawer is removed, there will be a large impedance shift at the Tx amplifier. This can be detected and power can be shut off to avoid human exposure. It is also easy to hermetically seal off the relay coil such that the user is not exposed to any voltage across the coil terminals.

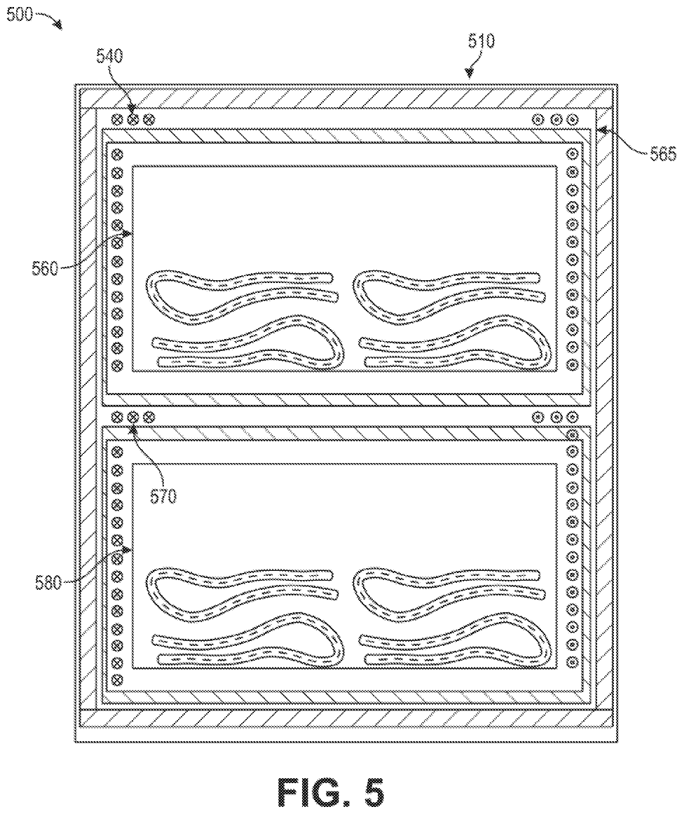

All of these features and benefits can be extended to multiple drawer assemblies as demonstrated in FIG. 5. FIG. 5 is an exemplary side view of a contactless charging chest of drawers 500, in accordance with some embodiments of the disclosure provided herein.

In one or more embodiments, contactless charging chest of draws 500 comprises drawers 560, 580, frame 510 and back iron 565. The frame comprises Tx coil1 540 and Tx coil 2 570 along other standard equipment found commonly in the art as previously described. Again, back iron is a conductive ground plane which reflects the electromagnetic radiation back into the contactless charging chest of draws comprises drawers.

In practice, Tx coil1 540 and Tx coil 2 570 are energized with alternating current. These produce magnetic fields which energize relay coil 1 and relay coil 2 through magnetic coupling. These in turn can be used to energize the Rx coils disposed in the garment.

In one or more embodiments, the two drawers may be independently enabled/disabled. In some embodiments, the whole assembly is linked by the same lines of magnetic flux. That is, one more primary coil on the frame are in phase with one another. This allows for the plurality of charging for both drawers to be enabled/disabled together. While both Tx coils should be driven in the phase (with possibly by the same amplifier), different waveforms can be used provided the average time varying flux is in the same field direction. This provides for varying charging requirements (frequency, etc.) for different device in different drawer.

In certain embodiments, an operating frequency centered around 400 kHz is used. But a wide range of operating frequencies are within scope of the present disclosure. One objective may desire a to operate at a frequency where power loss due to radiation is minimal. The relay coil is tuned to this operating frequency. The Tx coil can be tuned pretty close to this frequency but slight off-tuning could maintain operation.

A preferred embodiment may come more into tune as more receivers are added into the field. The receiver coils are non-resonant in this example, in order to simplify the circuits needed in the garment.

In some embodiments, the fundamental frequency is used throughout the chamber (drawer, chest thereof, etc.). That is, the near field inductive charging frequency which the relay coil is tuned to. In other embodiments, harmonics are used. In particular, the relay coil could be tuned to a harmonic of the Tx coil. As one skilled in the art can appreciate, many combinations are possible-all within the scope of the present disclosure.

In yet other embodiments, resonant cavities are created by the use of reflective walls. For example, the optional back iron could be used to surround the drawer thereby creating a resonant drawer, the size of which would be tuned to the drawer. In some embodiments, a standing wave could be generated using the fundamental frequency of the drawer. In other embodiments, higher harmonics could be exploited.

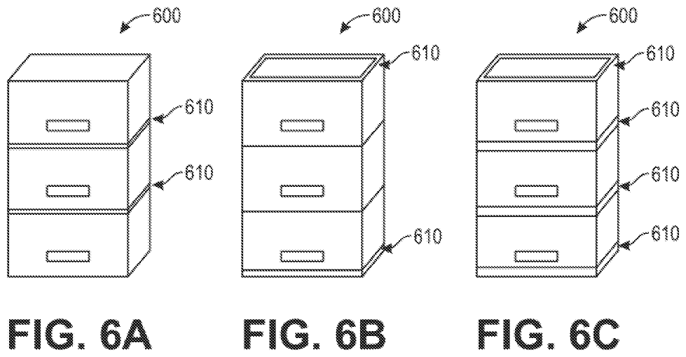

FIGS. 6A-C is an exemplary side view of a contactless charging chest of drawers 600, in accordance with some embodiments of the disclosure provided herein. For drawer chest with more than one or two drawers, the place of TX coils 610 can be used to adjust the coupling to each drawer as shown in FIGS. 6A-C. The choice of TX geometry for multi-drawer chest depends on the system and drawer design.

Three-drawer chest implementations have the following effects: FIG. 6A exhibits stronger TX-middle drawer coupling; FIG. 6B has a stronger TX-top and bottom drawer coupling; and FIG. 6C offers equal coupling to all drawers.

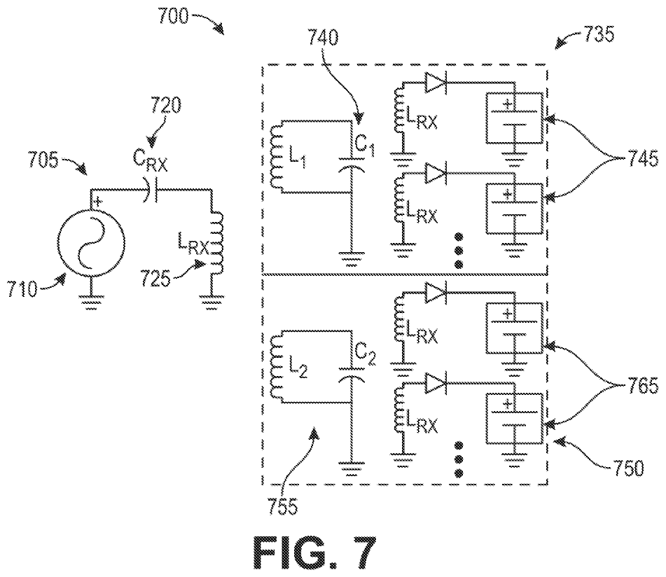

FIG. 7 depicts an exemplary functional schematic of a contactless two-drawer charging system 700, in accordance with some embodiments of the disclosure provided herein. Tx LC circuit 705 comprises a voltage source Vₛ 710, capacitor Cₜₓ 720, and inductor Lₜₓ 725.

Relay LC circuit 735 comprises capacitor C₁ 740 and inductor L₁ 780. Relay RLC circuit 750 comprises capacitor C₂ 755 and inductor L₂ 780. In practice, Tx RLC circuit 705 transfers power to relay LC circuit 735 and relay LC circuit 750. This stimulated emission in turn send power to Rx coils which are typically disposed in one or more garments. The power from the Rx is rectified through one or more diodes, after which it can be used to store DC power. Specifically, the power can be used to charge storage devices 745, 765. In one or more embodiments, charge storage devices are batteries. Whereas, in other, charge storage devices can be capacitors or any suitable power receiving device.

### SELECT EXAMPLES

Example 1 provides a charging apparatus configured to charge receivers comprising a first coil driven with an ac voltage and a second coil which is electromagnetically coupled to the first coil, wherein the charging apparatus is tuned such that the current in the second coil is largely insensitive to the number of receivers.

Example 2 provides for a charging apparatus according to any of the preceding and/or proceeding examples further comprising a frame.

Example 3 provides for a charging apparatus according to any of the preceding and/or proceeding examples, wherein the first coil is disposed in the frame.

Example 4 provides for a charging apparatus according to any of the preceding and/or proceeding examples further comprising a drawer.

Example 5 provides for a charging apparatus according to any of the preceding and/or proceeding examples, wherein the second coil is disposed in the drawer.

Example 6 provides for a charging apparatus according to any of the preceding and/or proceeding examples, wherein the drawer and the frame have no electrical contacts between them.

Example 7 provides for a charging apparatus according to any of the preceding and/or proceeding examples, wherein the devices are smart garments.

Example 8 provides for a charging apparatus according to any of the preceding and/or proceeding examples, wherein the frame has a ferrous surrounding.

Example 9 provides for a charging apparatus according to any of the preceding and/or proceeding examples, wherein the frame comprises an amplifier which is in electrical communication with the first coil.

Example 10 provides for a charging apparatus according to any of the preceding and/or proceeding examples further comprising a third coil disposed in second drawer.

Example 11 provides a method for wirelessly charging devices comprising energizing a first transmitter coil using an ac voltage, magnetically coupling the first transmitting coil to a first relay coil, and transmitting wireless power from the first relay coil, wherein the wireless power is configured to provide energy to devices and the current in the first relay coil is largely insensitive to the number of devices present.

Example 12 provides for a method for wirelessly charging devices according to any of the preceding and/or proceeding examples, wherein the devices include an array of receiver coils.

Example 13 provides for a method for wirelessly charging devices according to any of the preceding and/or proceeding examples further comprising saving the energy in batteries.

Example 14 provides for a method for wirelessly charging devices according to any of the preceding and/or proceeding examples further comprising disposing the first transmitter coil in a frame.

Example 15 provides for a method for wirelessly charging devices according to any of the preceding and/or proceeding examples further comprising disposing the first relay coil in a drawer.

Example 16 provides for a method for wirelessly charging devices according to any of the preceding and/or proceeding examples further comprising surrounding the frame with a highly conductive surrounding.

Example 17 provides for a method for wirelessly charging devices according to any of the preceding and/or proceeding examples further comprising disposing a second relay coil disposed in second drawer.

Example 18 provides for a method for wirelessly charging devices according to any of the preceding and/or proceeding examples further comprising disposing a second transmitter coil in the frame and driving the first and second transmitter coils in phase.

Example 19 provides for a method for wirelessly charging devices according to any of the preceding and/or proceeding examples further comprising determining magnetic coupling based at least on a change in power.

Example 20 provides a system for wirelessly charging smart garments, the system comprising a transmitter coil, a first relay coil, the first relay coil magnetically coupled the transmitting coil, a second relay coil, the second relay coil magnetically coupled the transmitting coil, and an array of receiving coils configured to receive wireless power from at least on of, the transmitter coil, the first relay coil, and the second relay coil, wherein the wireless power is configured to provide energy to smart garments and the current in the first relay coil is largely insensitive to the number of receiving coils present.

The following description and drawings set forth certain illustrative implementations of the disclosure in detail, which are indicative of several exemplary ways in which the various principles of the disclosure may be carried out. The illustrative examples, however, are not exhaustive of the many possible embodiments of the disclosure. Other objects, advantages and novel features of the disclosure are set forth in the proceeding in view of the drawings where applicable.

Having thus described several aspects and embodiments of the technology of this application, it is to be appreciated that various alterations, modifications, and improvements will readily occur to those of ordinary skill in the art. Such alterations, modifications, and improvements are intended to be within the spirit and scope of the technology described in the application. For example, those of ordinary skill in the art will readily envision a variety of other means and/or structures for performing the function and/or obtaining the results and/or one or more of the advantages described herein, and each of such variations and/or modifications is deemed to be within the scope of the embodiments described herein.

Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereto, inventive embodiments may be practiced otherwise than as specifically described. In addition, any combination of two or more features, systems, articles, materials, kits, and/or methods described herein, if such features, systems, articles, materials, kits, and/or methods are not mutually inconsistent, is included within the scope of the present disclosure.

The foregoing outlines features of one or more embodiments of the subject matter disclosed herein. These embodiments are provided to enable a person having ordinary skill in the art (PHOSITA) to better understand various aspects of the present disclosure. Certain well-understood terms, as well as underlying technologies and/or standards may be referenced without being described in detail. It is anticipated that the PHOSITA will possess or have access to background knowledge or information in those technologies and standards sufficient to practice the teachings of the present disclosure.

The PHOSITA will appreciate that they may readily use the present disclosure as a basis for designing or modifying other processes, structures, or variations for carrying out the same purposes and/or achieving the same advantages of the embodiments introduced herein. The PHOSITA will also recognize that such equivalent constructions do not depart from the spirit and scope of the present disclosure, and that they may make various changes, substitutions, and alterations herein without departing from the spirit and scope of the present disclosure.

The above-described embodiments may be implemented in any of numerous ways. One or more aspects and embodiments of the present application involving the performance of processes or methods may utilize program instructions executable by a device (e.g., a computer, a processor, or other device) to perform, or control performance of, the processes or methods.

In this respect, various inventive concepts may be embodied as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium) encoded with one or more programs that, when executed on one or more computers or other processors, perform methods that implement one or more of the various embodiments described above.

The computer readable medium or media may be transportable, such that the program or programs stored thereon may be loaded onto one or more different computers or other processors to implement various ones of the aspects described above. In some embodiments, computer readable media may be non-transitory media.

Note that the activities discussed above with reference to the FIGURES which are applicable to any integrated circuit that involves signal processing (for example, gesture signal processing, video signal processing, audio signal processing, analog-to-digital conversion, digital-to-analog conversion), particularly those that can execute specialized software programs or algorithms, some of which may be associated with processing digitized real-time data.

In some cases, the teachings of the present disclosure may be encoded into one or more tangible, non-transitory computer-readable mediums having stored thereon executable instructions that, when executed, instruct a programmable device (such as a processor or DSP) to perform the methods or functions disclosed herein. In cases where the teachings herein are embodied at least partly in a hardware device (such as an ASIC, IP block, or SoC), a non-transitory medium could include a hardware device hardware-programmed with logic to perform the methods or functions disclosed herein. The teachings could also be practiced in the form of Register Transfer Level (RTL) or other hardware description language such as VHDL or Verilog, which can be used to program a fabrication process to produce the hardware elements disclosed.

In example implementations, at least some portions of the processing activities outlined herein may also be implemented in software. In some embodiments, one or more of these features may be implemented in hardware provided external to the elements of the disclosed figures, or consolidated in any appropriate manner to achieve the intended functionality. The various components may include software (or reciprocating software) that can coordinate in order to achieve the operations as outlined herein. In still other embodiments, these elements may include any suitable algorithms, hardware, software, components, modules, interfaces, or objects that facilitate the operations thereof.

Any suitably-configured processor component can execute any type of instructions associated with the data to achieve the operations detailed herein. Any processor disclosed herein could transform an element or an article (for example, data) from one state or thing to another state or thing. In another example, some activities outlined herein may be implemented with fixed logic or programmable logic (for example, software and/or computer instructions executed by a processor) and the elements identified herein could be some type of a programmable processor, programmable digital logic (for example, an FPGA, an erasable programmable read only memory (EPROM), an electrically erasable programmable read only memory (EEPROM)), an ASIC that includes digital logic, software, code, electronic instructions, flash memory, optical disks, CD-ROMs, DVD ROMs, magnetic or optical cards, other types of machine-readable mediums suitable for storing electronic instructions, or any suitable combination thereof.

In operation, processors may store information in any suitable type of non-transitory storage medium (for example, random access memory (RAM), read only memory (ROM), FPGA, EPROM, electrically erasable programmable ROM (EEPROM), etc.), software, hardware, or in any other suitable component, device, element, or object where appropriate and based on particular needs. Further, the information being tracked, sent, received, or stored in a processor could be provided in any database, register, table, cache, queue, control list, or storage structure, based on particular needs and implementations, all of which could be referenced in any suitable timeframe.

Any of the memory items discussed herein should be construed as being encompassed within the broad term ‘memory.’ Similarly, any of the potential processing elements, modules, and machines described herein should be construed as being encompassed within the broad term ‘microprocessor’ or ‘processor.’ Furthermore, in various embodiments, the processors, memories, network cards, buses, storage devices, related peripherals, and other hardware elements described herein may be realized by a processor, memory, and other related devices configured by software or firmware to emulate or virtualize the functions of those hardware elements.

Further, it should be appreciated that a computer may be embodied in any of a number of forms, such as a rack-mounted computer, a desktop computer, a laptop computer, or a tablet computer, as non-limiting examples. Additionally, a computer may be embedded in a device not generally regarded as a computer but with suitable processing capabilities, including a personal digital assistant (PDA), a smart phone, a mobile phone, an iPad, or any other suitable portable or fixed electronic device.

Also, a computer may have one or more input and output devices. These devices can be used, among other things, to present a user interface. Examples of output devices that may be used to provide a user interface include printers or display screens for visual presentation of output and speakers or other sound generating devices for audible presentation of output. Examples of input devices that may be used for a user interface include keyboards, and pointing devices, such as mice, touch pads, and digitizing tablets. As another example, a computer may receive input information through speech recognition or in other audible formats.

Such computers may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks or wired networks.

Computer-executable instructions may be in many forms, such as program modules, executed by one or more computers or other devices. Generally, program modules include routines, programs, objects, components, data structures, etc. that performs particular tasks or implement particular abstract data types. Typically, the functionality of the program modules may be combined or distributed as desired in various embodiments.

The terms “program” or “software” are used herein in a generic sense to refer to any type of computer code or set of computer-executable instructions that may be employed to program a computer or other processor to implement various aspects as described above. Additionally, it should be appreciated that according to one aspect, one or more computer programs that when executed perform methods of the present application need not reside on a single computer or processor, but may be distributed in a modular fashion among a number of different computers or processors to implement various aspects of the present application.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

When implemented in software, the software code may be executed on any suitable processor or collection of processors, whether provided in a single computer or distributed among multiple computers.

Computer program logic implementing all or part of the functionality described herein is embodied in various forms, including, but in no way limited to, a source code form, a computer executable form, a hardware description form, and various intermediate forms (for example, mask works, or forms generated by an assembler, compiler, linker, or locator). In an example, source code includes a series of computer program instructions implemented in various programming languages, such as an object code, an assembly language, or a high-level language such as OpenCL, RTL, Verilog, VHDL, Fortran, C, C++, JAVA, or HTML for use with various operating systems or operating environments. The source code may define and use various data structures and communication messages. The source code may be in a computer executable form (e.g., via an interpreter), or the source code may be converted (e.g., via a translator, assembler, or compiler) into a computer executable form.

In some embodiments, any number of electrical circuits of the FIGURES may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), memory elements, etc. can be suitably coupled to the board based on particular configuration needs, processing demands, computer designs, etc.

Other components such as external storage, additional sensors, controllers for audio/video display, and peripheral devices may be attached to the board as plug-in cards, via cables, or integrated into the board itself. In another example embodiment, the electrical circuits of the FIGURES may be implemented as standalone modules (e.g., a device with associated components and circuitry configured to perform a specific application or function) or implemented as plug-in modules into application-specific hardware of electronic devices.

Note that with the numerous examples provided herein, interaction may be described in terms of two, three, four, or more electrical components. However, this has been done for purposes of clarity and example only. It should be appreciated that the system can be consolidated in any suitable manner. Along similar design alternatives, any of the illustrated components, modules, and elements of the FIGURES may be combined in various possible configurations, all of which are clearly within the broad scope of this disclosure.

In certain cases, it may be easier to describe one or more of the functionalities of a given set of flows by only referencing a limited number of electrical elements. It should be appreciated that the electrical circuits of the FIGURES and its teachings are readily scalable and can accommodate a large number of components, as well as more complicated/sophisticated arrangements and configurations. Accordingly, the examples provided should not limit the scope or inhibit the broad teachings of the electrical circuits as potentially applied to a myriad of other architectures.

Also, as described, some aspects may be embodied as one or more methods. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

### Interpretation of Terms

All definitions, as defined and used herein, should be understood to control over dictionary definitions, definitions in documents incorporated by reference, and/or ordinary meanings of the defined terms. Unless the context clearly requires otherwise, throughout the description and the claims:

“comprise,” “comprising,” and the like are to be construed in an inclusive sense, as opposed to an exclusive or exhaustive sense; that is to say, in the sense of “including, but not limited to”.

“connected,” “coupled,” or any variant thereof, means any connection or coupling, either direct or indirect, between two or more elements; the coupling or connection between the elements can be physical, logical, or a combination thereof.

“herein,” “above,” “below,” and words of similar import, when used to describe this specification shall refer to this specification as a whole and not to any particular portions of this specification.

“or,” in reference to a list of two or more items, covers all of the following interpretations of the word: any of the items in the list, all of the items in the list, and any combination of the items in the list.

the singular forms “a”, “an” and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present) depend on the specific orientation of the apparatus described and illustrated. The subject matter described herein may assume various alternative orientations. Accordingly, these directional terms are not strictly defined and should not be interpreted narrowly.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined.

Elements other than those specifically identified by the “and/or” clause may optionally be present, whether related or unrelated to those elements specifically identified. Thus, as a non-limiting example, a reference to “A and/or B”, when used in conjunction with open-ended language such as “comprising” may refer, in one embodiment, to A only (optionally including elements other than B); in another embodiment, to B only (optionally including elements other than A); in yet another embodiment, to both A and B (optionally including other elements); etc.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

As used herein, the term “between” is to be inclusive unless indicated otherwise. For example, “between A and B” includes A and B unless indicated otherwise.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively.

Numerous other changes, substitutions, variations, alterations, and modifications may be ascertained to one skilled in the art and it is intended that the present disclosure encompass all such changes, substitutions, variations, alterations, and modifications as falling within the scope of the appended claims.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke 35 U.S.C. § 112(f) as it exists on the date of the filing hereof unless the words “means for” or “steps for” are specifically used in the particular claims; and (b) does not intend, by any statement in the disclosure, to limit this disclosure in any way that is not otherwise reflected in the appended claims.

The present invention should therefore not be considered limited to the particular embodiments described above. Various modifications, equivalent processes, as well as numerous structures to which the present invention may be applicable, will be readily apparent to those skilled in the art to which the present invention is directed upon review of the present disclosure.

What is claimed is:

1. A charging apparatus configured to charge receivers comprising:
a first coil driven with an ac voltage; and
a second coil which is electromagnetically coupled to the first coil;
wherein the charging apparatus is tuned such that the current in the second coil is largely insensitive to the number of receivers.

2. The charging apparatus of claim 1 further comprising a frame.

3. The charging apparatus of claim 2, wherein the first coil is disposed in the frame.

4. The charging apparatus of claim 3 further comprising a drawer.

5. The charging apparatus of claim 4, wherein the second coil is disposed in the drawer.

6. The charging apparatus of claim 5, wherein the drawer and the frame have no electrical contacts between them.

7. The charging apparatus of claim 1, wherein the devices are smart garments.

8. The charging apparatus of claim 2, wherein the frame has a ferrous surrounding.

9. The charging apparatus of claim 2, wherein the frame comprises an amplifier which is in electrical communication with the first coil.

10. The charging apparatus of claim 5 further comprising a third coil disposed in second drawer.

11. A method for wirelessly charging devices comprising:
energizing a first transmitter coil using an ac voltage;
magnetically coupling the first transmitting coil to a first relay coil; and
transmitting wireless power from the first relay coil;
wherein the wireless power is configured to provide energy to devices and the current in the first relay coil is largely insensitive to the number of devices present.

12. The method of claim 11, wherein the devices include an array of receiver coils.

13. The method of claim 12 further comprising saving the energy in batteries.

14. The method of claim 13 further comprising disposing the first transmitter coil in a frame.

15. The method of claim 14 further comprising disposing the first relay coil in a drawer.

16. The method of claim 15, further comprising surrounding the frame with a highly conductive surrounding.

17. The method of claim 15 further comprising disposing a second relay coil disposed in second drawer.

18. The method of claim 17 further comprising disposing a second transmitter coil in the frame and driving the first and second transmitter coils in phase.

19. The method of claim 11 further comprising determining magnetic coupling based at least on a change in power.

20. A system for wirelessly charging smart garments, the system comprising:
a transmitter coil;
a first relay coil, the first relay coil magnetically coupled the transmitting coil;
a second relay coil, the second relay coil magnetically coupled the transmitting coil; and
an array of receiving coils configured to receive wireless power from at least on of, the transmitter coil, the first relay coil, and the second relay coil;
wherein the wireless power is configured to provide energy to smart garments and the current in the first relay coil is largely insensitive to the number of receiving coils present.
